(19) United States
(12) Patent Application Publication
(10) Pub. No.: US 2008/0052494 A1
(43) Pub. Date: Feb. 28, 2008

(54) Method And Device For Operand Processing In A Processing Unit

(76) Inventors: Reinhard Weiberle, Vaihingen/Enz (DE); Thomas Kottke, Ehningen (DE); Andreas Steininger, Wien (AT)

Correspondence Address: KENYON & KENYON LLP, ONE BROADWAY, NEW YORK, NY, 10004, US

(21) Appl. No.: 10/577,022

(22) PCT Filed: Aug. 7, 2004
(86) PCT No.: PCT/DE04/01779

§ 371 Date: Apr. 9, 2007

(30) Foreign Application Priority Data
Oct. 24, 2003 (DE) 103 49 580.0

(51) Int. Cl. G06F 15/76

(52) U.S. Cl. 712/43; 712/E09.003

(57) ABSTRACT

A method and a device for operand processing in a processing unit having at least two execution units, which are able to be operated at a predefinable clock cycle. The execution units are controlled by control signals for the processing of the operands and a switch is possible between a first operating mode and a second operating mode. In the first operating mode, both execution units are supplied with the same operands, and in the second operating mode different operands are supplied to both execution units, and both execution units are controlled by the same control signals for the processing of the operands in the first operating mode, and both execution units are controlled by different control signals for the processing of the operands in the second operating mode.

### RELATED ART

The present invention is based on a method and a device for operand processing in a processor unit having at least two execution units and a switchover between at least two operating modes, and also a corresponding processing unit according to the definition of the species in the independent claims.

Such processing units having at least two integrated execution units are also known as dual core architectures or multi-core architectures. According to the current related art, such dual core architectures or multi-core architectures are proposed mainly for two reasons:

First of all, their use allows the output to be increased, i.e., enhanced performance, by regarding and treating the two execution units or cores as two computing units on a semiconductor component. In this configuration the two execution units or cores process different programs or tasks. This allows the performance to be increased, which is why this configuration is called performance mode.

Apart from being used as super-scalar processors, the second reason for realizing a dual core or multi-core architecture is the increase in the reliability due to the fact that both programs process the same program in a redundant manner. The results of the two execution units are compared, and an error can then be detected in the comparison for agreement. In the following text this configuration is called safety mode.

The two mentioned configurations are normally included in the dual architecture or multi-core architecture exclusively, that is, the computer having the at least two execution units is in principle operated in only one mode: either the performance mode or the safety mode.

It is the object of the present invention to allow the combined operation of such a dual core or multi-core processor unit with respect to at least two operating modes, in such a way that an optimal switchover is achievable between at least two operating modes, i.e., between safety mode and performance mode, in particular.

### SUMMARY OF THE INVENTION

For one, redundant processing of the operands or redundant execution of the programs or tasks, i.e., also of task programs, program parts, code blocks or also individual commands, is desired for reasons of safety. On the other hand, however, for cost considerations, it is not desirable to hold completely redundant hardware in readiness when executing functions that are not safety-critical. According to the present invention this conflict of goals is resolved by an optimized switch between at least two operating modes with one processing unit.

The present invention therefore is based on a method and a device for the processing of operands in a processor having at least two execution units which are able to be operated at a predefinable clock pulse. The execution units are controlled by control signals for the processing of the operands, and a switch is possible between a first operating mode and a second operating mode. In the first operating mode, both execution units are advantageously supplied with identical operands, and in the second operating mode different operands are supplied to both execution units; moreover, in the first operating mode both execution units are controlled by identical control signals for the processing of the operands, and in the second operating mode both execution units are controlled by different control signals for the processing of the operands.

In the first operating mode the operands are advantageously supplied to the execution units as a function of the clock cycle of the execution units, as full cycle, and in the second operating mode the operands are supplied for processing at a second clock cycle, which is faster than the full cycle.

For practical purposes the clock cycle of the execution units and the full cycle are selected to be identical; in one special embodiment the faster, second clock cycle, as half cycle, is twice as fast as the full cycle.

In an advantageous manner, the operands are processed in synchrony in both operating modes; a synchronous processing of the operands in the first operating mode and an asynchronous processing of the operands in the second operating mode is possible as well.

For reasons of safety it may be provided that comparators compare the operands or data derived from the operands, such as ECC codes formed therefrom, for agreement, and an error will be detected in the case of deviations. It is also possible that states produced in the processing of the operands, such as derived data in the form of ECC codes or results, are compared for agreement by comparators, an error being detected here as well if deviations have occurred. In both cases, depending on the operating mode, it may be stipulated in the comparison whether such a comparison will be implemented or which operands, data, states or results will be compared.

Prior to being written to a bus, the states or results are then released by a release signal, such release being implemented as a function of the operating mode and the result of the comparison, so that the states or results are releasable either simultaneously or successively.

In addition to the at least two execution units, which are able to be operated at a predefinable clock cycle, the device or the processing unit of the present invention having such a device includes a control unit, in particular in the form of a switchover device, which switches between a first operating mode and a second operating mode and controls the execution units by control signals for the processing of the operands, this control unit being connected to the execution units and additional feed units. The control unit cooperates with the feed units in such a way that identical operands are supplied to both execution units in the first operating mode, and different operands are supplied to both execution units in the second operating mode. The control unit is designed such that in the first operating mode both execution units are triggered by the same control signals for the processing of the operands, and in the second operating mode both execution units are triggered by different control signals for the processing of the operands.

For practical purposes the control unit and the feed units are designed such that in the first operating mode the operands are preferably supplied to the execution units as a function of the clock cycle of the execution units, as full cycle, and in the second operating mode the operands are supplied for processing at a second clock cycle, which is faster than the full cycle.

The two execution units may be embodied solely as arithmetic logic units (ALUs) or also as complete computer cores or processing units (CPUs). In an advantageous manner the present invention may thus be used as execution units in a processing unit for all such at least dual-type components for operand processing.

The feed units in the form of a register system are configured such that at least one operand register is provided and at least one buffer register is present between the operand register and each execution unit; the feed units and the execution units are designed in such a way that they operate, or are operated, on the basis of different clock cycles in the second operating mode—performance mode PM—, in particular that the feed units are designed such that they operate or are operated at a faster clock pulse than the execution units in the second operating mode, in particular at a clock pulse that is twice as fast.

A decoder by which a switchover condition is detectable is preferably provided, the decoder operating, or being operated, on the basis of the same cycle as the feed unit.

For practical purposes first switching means are optionally provided, which are embodied such or are able to be operated in such a way that they switch the feed means as a function of the first or second operating mode, and/or second switching means are provided, which are configured such or are able to be operated in such a way that they switch the execution units as a function of the first or second operating mode.

The feed units and the execution units are advantageously designed to operate, or to be operated, on the basis of the same clock cycle in the first operating mode, the safety operating mode, and, in particular, to operate or be operated in a synchronous manner.

Further advantages and advantageous refinements are derived from the specification as well as from the features of the claims.

### BRIEF DESCRIPTION OF THE DRAWING

The present invention is elucidated in the following with reference to the figures illustrated in the drawing.

FIG. 1 and FIG. 2 each show a processing unit having a duplicate arithmetic logic unit and an operand register system each having one operand register and one buffer register.

FIG. 3 also shows such a processing unit having a duplicate execution unit as well as an operand register system that differs from FIGS. 1 and 2, having two pairs of operand registers and a corresponding number of buffer registers in each case.

FIG. 4 shows different clock cycles for the feeding and processing of the operands, in particular half-cycle and full cycle.

FIG. 5 also shows a processing unit having a duplicate execution unit similar to FIG. 3, only one operand input being available to the execution units, and only one operand register being provided in the operand-register system.

### DESCRIPTION OF THE EXEMPLARY EMBODIMENTS

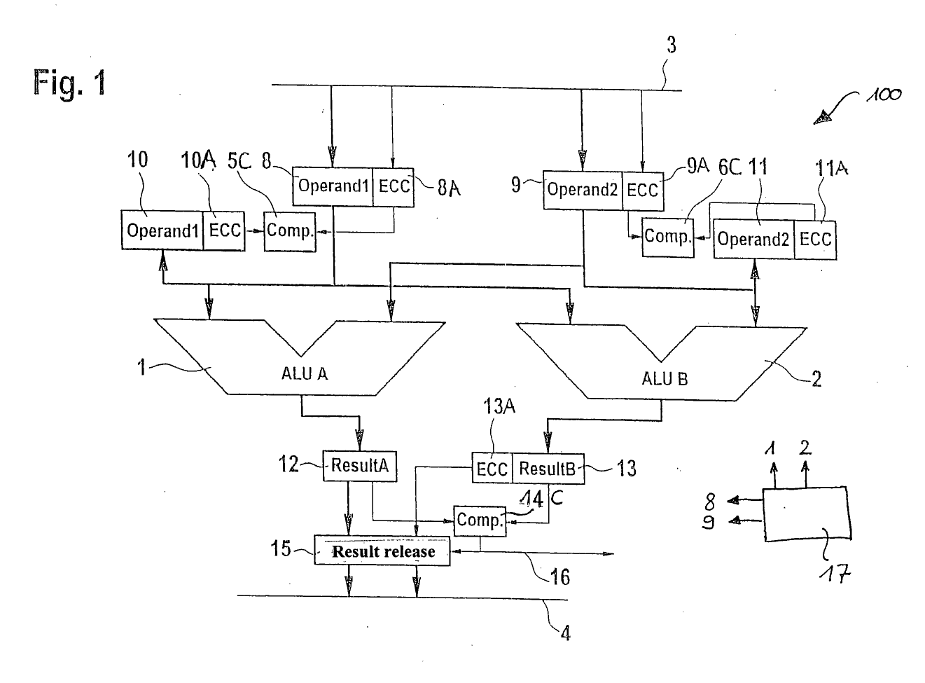

Unless noted otherwise, identical and/or functionally equivalent elements have been provided with matching reference numerals in FIGS. 1, 2, 3 and 5 of the drawing.

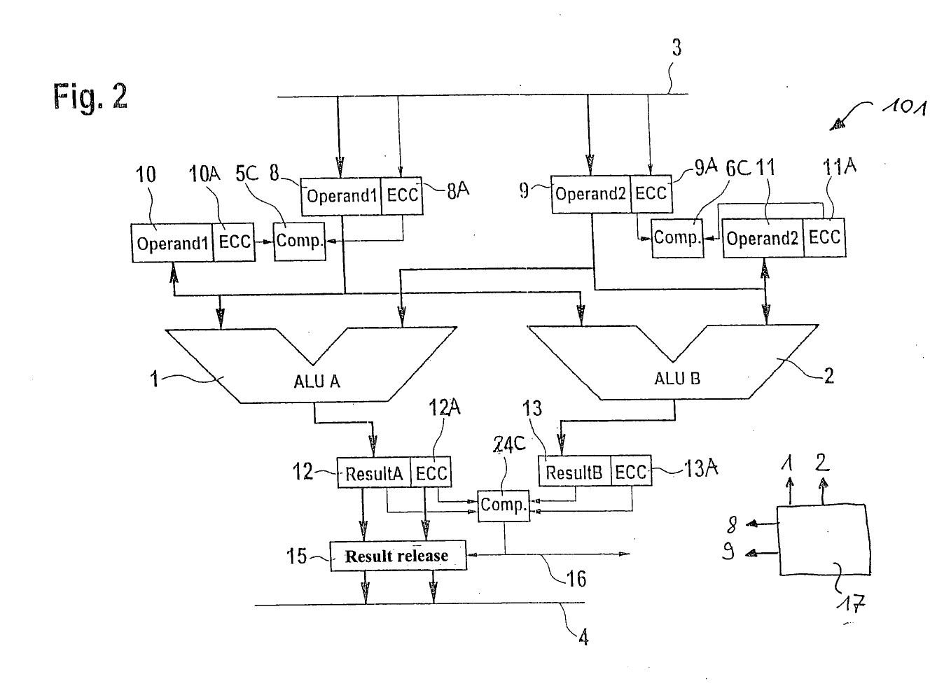

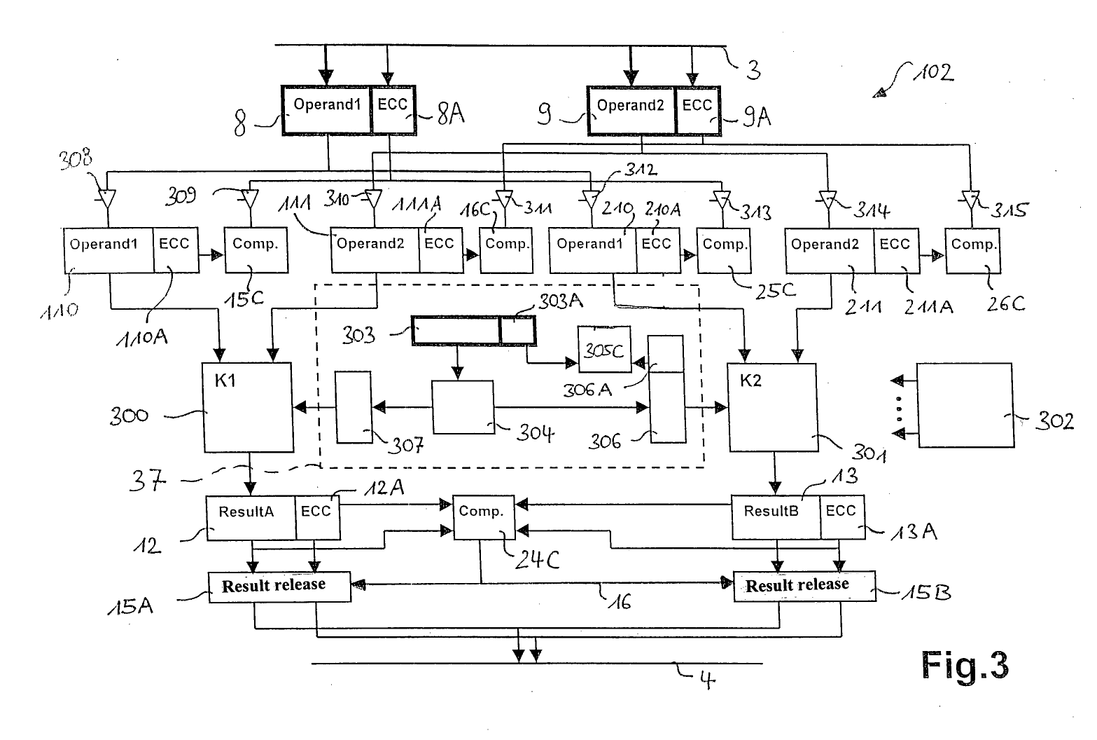

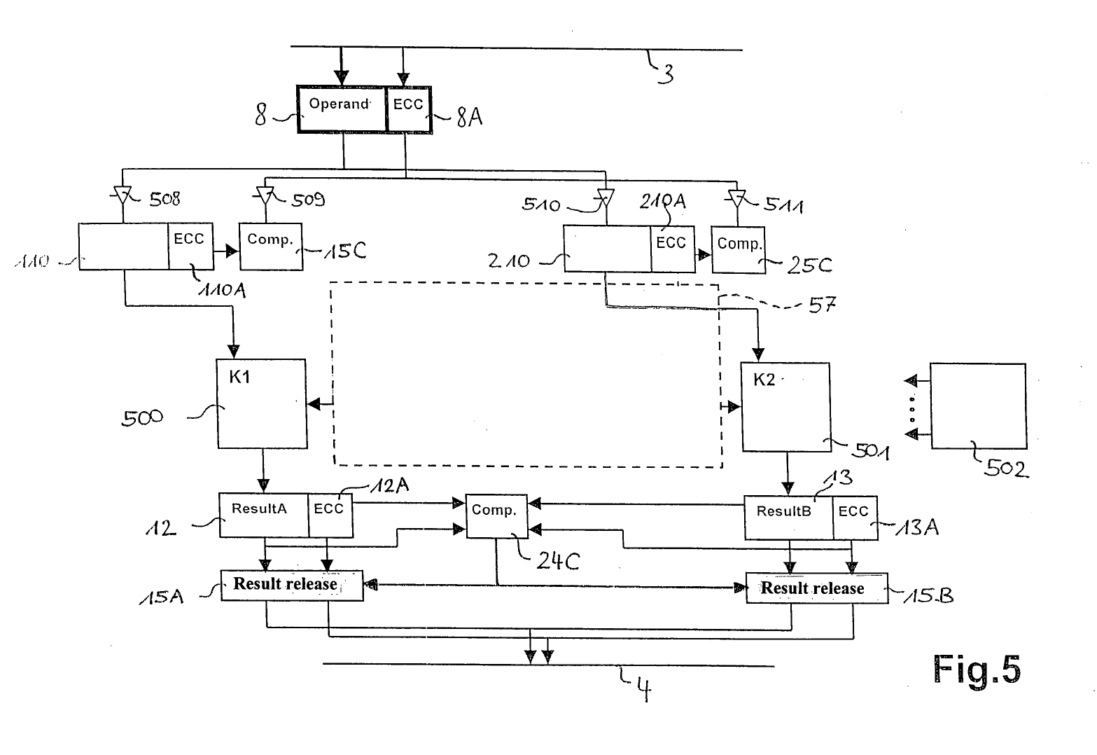

The components of the processing unit that are not directly designed according to the present invention, such as memory units, peripheral units, the rest of the cores or CPUs in the illustration of the arithmetic logic unit, etc., are not directly shown in FIGS. 1 and 2 for reasons of clarity. However, the two arithmetic logic units, ALU A and ALU B, could just as well correspond to FPUs or complete cores or CPUs within the framework of the present invention, so that the present invention could also be used for complete dual-core architectures as will be described later in FIGS. 3 and 5. However, in FIGS. 1 and 2 it is preferred that only the arithmetic logic unit is duplicated and the other components of the CPU be safeguarded by other fault-detecting mechanisms.

In FIGS. 1 and 2, reference numerals 1 and 2 each denote individual arithmetic logic units (ALUs), or also floating point units (FPUs) as execution units. In this exemplary embodiment the arithmetic logic unit (ALU) is designed redundantly. Each individual ALU 1, 2 has two inputs and one output. In test operation, the operands to be executed may be inserted into the inputs of ALUs 1, 2 directly from bus 3, or they may be stored in advance in an operand register 8, 9 specifically provided for this purpose. These operand registers 8, 9 are directly coupled to data bus 3. Both ALUs 1, 2 are thus supplied from the same operand registers 8, 9. In addition, it is possible that the operands in question have already been provided with ECC coding via the bus, the operands being stored in register areas 8A, 9A. That is to say, at all locations in FIGS. 1 and 2 (and also in FIGS. 3 and 5 as explained later) where ECC is indicated, the data may be safeguarded through the use of an ECC (error correction code).

Such methods for error detection take many different forms, the basic condition being the safeguarding by error detection or an error correction code, i.e., a signature. In the simplest case this signature may be made up of only one signature bit, such as a parity bit. On the other hand, the protection may also be realized by more complex ED (error detection) codes such as a Berger code or a Bose-Lin code, etc, or also by a more complex ECC, such as a Hamming code, etc., in order to allow reliable error detection by a corresponding bit number. However, it is also possible to use, for instance, a generator table (hardwired or in software) as code generator in order to assign to specific input patterns of the bits a desired code pattern of any desired length within the framework of the address. This ensures the security of the data, in particular by the correction function. Nevertheless, in the safety-critical mode, i.e., in safety mode SM, redundant processing of the safety-critical programs takes place in both execution units, i.e., in both ALUs 1 and 2, so that errors in the execution units are uncovered through a comparison for agreement. In the following text it will not be differentiated between the possible error coding options, the term ECC being used in general.

To increase the performance, the programs or tasks or program parts, code blocks or commands that are not safety-relevant or safety-critical may be calculated in both execution units in distributed fashion in order to increase the processing speed and thus the performance. This is done in the so-called performance mode PM.

When the specific operands are coupled into ALUs 1, 2, careful attention must be paid to inputting the correct data. For instance, if the same faulty operands are coupled into both ALUs 1, 2, no error can be detected at the output of ALUs 1, 2. Therefore, it must be ensured that at least one of ALUs 1 or 2 receives a correct data-input value, or also that both ALUs 1, 2 receive different, but incorrect data-input values. This is ensured in that a check sum, i.e., an ECC as mentioned earlier, is formed from at least one input value of one ALU 1, 2. In a specially provided comparator unit 5C, 6C, ECC coding 10A, 11A from these additional data registers or buffer registers 10, 11 is compared with ECC coding 8A, 9A from the original source register 8, 9. The input data from registers 10, 11 also may optionally be compared with those from source registers 8, 9. If a difference results in the ECC coding or in the operands, this will be interpreted as an error and an error signal will be output, possibly displayed and possibly corrected. This comparison advantageously takes place during processing of the operands in ALUs 1, 2, so that this error detection and error correction on the input side causes virtually no loss in performance. If one of comparator units 5C, 6C detects an error, the calculation may be repeated during the next cycle. A shaded register can be used for this purpose in order to always safeguard the operands of the most recent calculation so that they are rapidly available again in the event of an error. However, such a shaded register will not have to be provided if the specific buffer registers 10, 11 are overwritten again only via a release signal based on the absence of an error. If an error has occurred, comparator units 5C, 6C supply an error signal, causing buffer registers 10, 11 not to be overwritten again.

ALUs 1, 2 each generate one result on the output side. The result data provided by ALUs 1, 2 and/or their ECC coding are/is stored in result registers 12, 13, 12A, 13A. These result data and/or their coding are compared to each other in comparator unit 14C, 24C. If no error has occurred, a release signal 16 is generated. This release signal 16 is coupled into release device 15, which is thereby induced to write the result data to a bus 4. The result data are then able to be processed again via bus 4.

Release signal 16 also may be utilized to disconnect registers 8 through 11 again, so that the next operands may be read out from bus 3 and processed in ALUs 1, 2.

The system in FIG. 1 does not check the result itself. Here, the result data are merely compared with each other in comparator unit 14C. A check of the ECC coding of the result data is first possible by the system in FIG. 2 where both the result data and their ECC coding are compared with each other in comparator unit 24C.

All transient errors, permanent errors and also execution-time errors are detected by the fault-detection systems shown in FIGS. 1 and 2. Execution-time errors within an ALU 1, 2 are detected if the result does not arrive at the corresponding comparator unit and/or the corresponding result registers or if it arrives too late and a comparison thus takes place with a partial result. By protecting the operand registers and buffer registers 8, 9, 10, 11 by error-detection code and error-correction code and by comparing the final results the specific error location and error instant are able to be localized precisely. This allows a very fast response to a transient fault.

The following possibilities for error localization therefore result:

If a comparison of the result data in comparator unit 14C or 24C results in a difference, an error within ALUs 1, 2 may be assumed.

If a comparison of the ECC coding in one of comparator units 5C, 6C indicates a difference, a faulty signal from bus 3 or from upstream components may be assumed.

If a comparison of the ECC coding in comparator unit 24C shows a difference, faulty coding of the results may be assumed.

For the switch between mentioned safety mode SM where redundant processing and checking take place, and performance mode PM where the performance is increased by separate program processing, a control unit 17 is used, which, in particular, assumes the function of a switchover device. Using this switchover device 17, at least elements 8, 9 and 1, 2 are switched in such a way that in the one case, i.e., in safety mode SM, redundant program processing takes place, in particular synchronous program processing, and in the second operating mode, performance mode PM, parallel processing of different programs or operands is able to be implemented. To this end, switches or switching means may optionally be provided, which, for one, may be situated inside elements 8, 9 or 1, 2 or also in switchover device or control unit 17, or which may be included in the circuit arrangement separately, in addition to elements 8, 9, 1, 2 or 17.

For the switchover, the programs or task programs or program parts, i.e., code blocks, or also the commands or the operands themselves, are marked by an identification by which it is detectable whether they are safety-relevant and must thus be processed in safety mode SM, or whether they may be made available to performance mode PM. This can be done by using at least one bit, or also by marking the following sequence with the aid of a special command. A switchover may take place in the same way by accessing a specific, predefinable memory address via which performance mode PM or safety mode SM will then be triggered.

The programs, for one, may include application functions, i.e., in particular be provided to control operating sequences in a vehicle, or else the switchover is implemented with respect to programs in which the identification occurs on the level of the operating system, i.e., entire operating-system tasks being assigned, for instance.

In a decoding, control unit 17 as switchover device may then recognize whether or not the following calculation is safety-relevant and should thus be executed in safety mode SM. If this is the case, the data are forwarded to both execution units 1 and 2. If this is not the case, i.e., if the further processing is carried out in performance mode PM, the data is made available to one execution unit, and the next command—provided it is not safety-relevant either—may then be forwarded to the second execution unit simultaneously, so that the programs or operands are processed in parallel at higher processing speed.

In the first case (SM), for instance, the calculation of the result takes the same length of time with synchronous processing in both units. That is to say, in safety mode with synchronous processing the results are available simultaneously. These data are then provided with code again at the output, analogously to 12 and 13, and the data and/or the coding of these data are compared with result A and result B in the manner described in FIGS. 1 and 2. If they match, the data are released. Otherwise, one of the mentioned error reactions occurs. In the second case, i.e., in performance mode PM, when parallel processing of the data takes place, comparator 14C or 24C at the output of the two arithmetic logic units is not triggered, and the results, result A and result B, are written back into the register bank one after the other and may also be output one after the other in the way it is also done in a super-scalar processor.

Since the same programs are processed in parallel in safety mode SM, i.e., in redundant fashion, a switchover occurs only if in performance mode PM a switchover is provided for both branches, i.e., register 8 and ALU 1 as well as register 9 and ALU 2, on the basis of the identification, for example. If fully synchronous processing takes place, i.e., processing of the program at the same time, this is the case to begin with; if the program is not processed in synchrony, or if it is processed asynchronously, the faster execution unit must wait for the lagging execution unit, so that control unit 17 switches over only when both identifications are present or have been analyzed. Such synchronism also must be generated —either by forced time synchronism or by waiting—for the result comparison or the ECC and result comparison according to blocks 12, 13 and 14C, 24C as well as 12A and 13A.

In an additional example according to the present invention, FIG. 3 illustrates a circuit system having two execution units which, as components K1 and K2, are denoted by 300 and 301 here. In contrast to the previously used arithmetic logic units (ALUs) in FIG. 1 and FIG. 2, these two components now represent, for instance, complete processor cores, so-called cores or also CPUs. The two components K1 and K2 also have two inputs and one output. Here, too, the operands to be executed may be directly coupled into the inputs of the components from bus 3, or they may be stored in advance in operand registers 8 and 9 provided for this purpose. The further comments regarding operand registers 8 and 9 as well as the corresponding ECC coding are comparable to those of FIGS. 1 and 2 and apply here as well. In principle, the same is also true for the post-connected data registers having an optional ECC component which are denoted by 110, 11, 210, 211 in FIG. 3, and for the corresponding ECC coding in 110A, 111A, 210A, 211A. Compared to FIGS. 1 and 2, however, two individual pairs of buffer registers have been connected in series to the individual components as an additional specific embodiment. As already described in connection with FIGS. 1 and 2, faults in the feeding of operands, i.e., in the data-input values, are monitored by check-sum generation (ECC). Like in FIGS. 1 and 2, comparator units or comparators 15C, 16C, 25C and 26C according to the number of registers to be compared have been provided here as comparison means for error detection. Thus, if a difference results in the ECC coding or the operands, this is interpreted as an error and an error signal may be output, the error stored, the error displayed, an error reaction be initiated as a function of the error, in particular an emergency operation be started or an error correction. Here, too, as in FIGS. 1 and 2, a calculation may be repeated in the next clock cycle if an error has occurred, a shaded register possibly being used here as well.

The results or states of the operand processing—result A or result—are then compared like in FIG. 2 (the ECC codes being optional again) and checked for errors. As in FIG. 2, registers 12 and 13 with ECC components 12A and 13A are utilized and comparator 24C as comparison means. In contrast to FIG. 2, two result-release blocks, 15A and 15B, are used in this case, via which the result is released to bus 4 by means of release signal 16.

In this FIG. 3, where elements of processor unit 102 are shown, which are configured according to the present invention, the function of the control unit—denoted by 302 here—will now be examined in greater detail. For reasons of clarity, the outputs, which are indicated by the arrows on control unit 302, are not shown in detail since first switching means 308 through 315, control circuit 37 or the elements included therein, and—optionally—operand registers 8 and 9 and—also optionally—buffer registers 110, 111 and 210, 211 are triggered thereby.

Here, too, control unit 302 has a switching function in a certain sense, in order to change from one operating mode to another operating mode. That is to say, in particular a change takes place from safety mode SM to performance mode PM and vice versa, which is accomplished, for instance, through the use of predefinable control signals according to the particular operating mode.

Depending on the detected operating mode, the aforementioned elements are therefore triggered in an appropriate manner as a function of a switchover condition, as already explained in connection with FIGS. 1 and 2. Control circuit 37 includes a decoder 303, a second switching means 304, optionally two registers or latches 307 and 306. Here, too, once again for reasons of security, the ECC codings from region 303A assigned to the decoder and from region 306A assigned to register 306 may be compared with the aid of comparator 305C. This control circuit 37 or also portions thereof, may also be accommodated in control unit 302 or be identical with it.

When using an identification or identifier as switchover condition or also a predefinable memory address as discussed in connection with FIGS. 1 and 2, the control unit can determine in a decoding whether or not the following calculation is safety-relevant. If this is the case, i.e., if the operands are processed in safety mode SM, the same operands—operand 1 and operand 2 in this case—are forwarded to both execution units 300 and 301. Both execution units are triggered by the same control signals for the processing of the operands. The feeding of the operands to the execution units and the clock cycle of the execution units for the processing of the operands are adapted to one another. In a preferred specific embodiment, the feed units (i.e., at least operand registers 8 and 9) and the execution units as well as decoder 303 each operate at the same clock cycle, i.e., the same cycle. In particular, both sides—i.e., the feed unit having operand register 8 and execution unit 300—operate at the same clock cycle, and the feed unit having operand register 9 and execution unit 301 likewise operate at the same clock cycle. In a preferred specific embodiment both sides are synchronous, so that the operands are processed in synchrony in safety mode SM, which means that the result or a corresponding processing state, result A and result B, of both sides is present in registers 12 and 13 at the same time.

The corresponding feed unit thus includes at least the corresponding operand register 8 or 9. Furthermore, depending on the specific embodiment, at least one buffer register 10 or 11 is possible in the feed unit in FIG. 1 or 2, or 110, 111 or 210, 211 in FIG. 3. Also included in the feed unit could be first switching means so that the operands may be switched through according to the clock cycle. These first switching means 308, 310, 312, 314 could be present either separately, as shown in FIG. 3, or they could be integrated in at least one of the corresponding registers (operand register 8 or 9, corresponding buffer register 10 or 11, 110, 111, 210, 211). Depending on whether an EEC coding is used, the individual register sections (10A, 11A in FIGS. 1 and 2, or 110A, 111A, 210A, 211A in FIG. 3) as well as the associated comparators (5C, 6C in FIGS. 1 and 2 as well as 15C, 16C, 25C, 26C in FIG. 3) are optionally part of the particular feed unit. The same applies to the first switching means within the framework of the ECC coding (309, 311, 313, 315 in FIG. 3), i.e., these are also optionally part of the particular feed unit and could likewise be separate or be integrated in at least one of the corresponding registers (ECC operand register 8A or 9A or corresponding buffer register 10A or 11A, 110A, 111A, 210A, 211A). The individual feed units thus correspond to the particular elements in the corresponding feed path to the execution units; it is possible to use the division as shown in FIGS. 1, 2, 3 or 5 or it is also possible to combine everything or parts into one component.

If the results or states of the operand processing are available simultaneously in safety mode, i.e., the first operating mode, they will subsequently be coded (ECC) again at the output of the individual execution unit in corresponding registers 12 with 12A and 13 with 13A, and the results or the processing states, result A, result B and/or the codings (ECC) of these results, are compared. Comparator 24C is used for this purpose. If they agree, the data will be released again via release signal 16 and written to bus 4 by units 15A and/or 15B. The release signal is preferably generated by the comparator, but may also be generated by the control unit. In safety mode SM the results are identical upon release and are therefore written to bus 4 once. If there is a difference, the results will not be released and not written to the bus, but written into an error register, for instance, or a flag or an error signal will be generated in order to initiate a display or a corresponding error reaction. The use of a shaded register, in particular, is possible here for the backwriting, as already described in connection with the operand registers in FIGS. 1, 2 and 3. In a special case, in safety mode SM, the operands may also first be conveyed to an execution unit, the error detection code EEC then be checked and the operands subsequently be supplied to the second execution unit, all of this taking place in the same cycle section, as full cycle.

If it is detected in accordance with the switchover condition that processing of the operands takes place in the second operating mode, performance mode PM, only one execution unit is provided with the corresponding operand(s), the following operand(s) (provided they are also to be processed in non-safety-relevant manner) being forwarded to the second execution unit virtually simultaneously (in the same full cycle), i.e, in the next half-cycle section. The feed units operate at a faster clock cycle than the two execution units, in particular at double the clock cycle, i.e., at the so-called half-cycle. No result comparison takes place in this not safety-critical operand processing, and the individual results or states are written to bus 4 correspondingly, in particular alternately. No release is necessary in this case. In particular in this second operating mode, performance mode PM, it is conceivable that both sides, especially the execution units, are not synchronized and thus operate asynchronously. Collisions in writing to the bus may be prevented by time conditions such as time slots, event control or by arbitration.

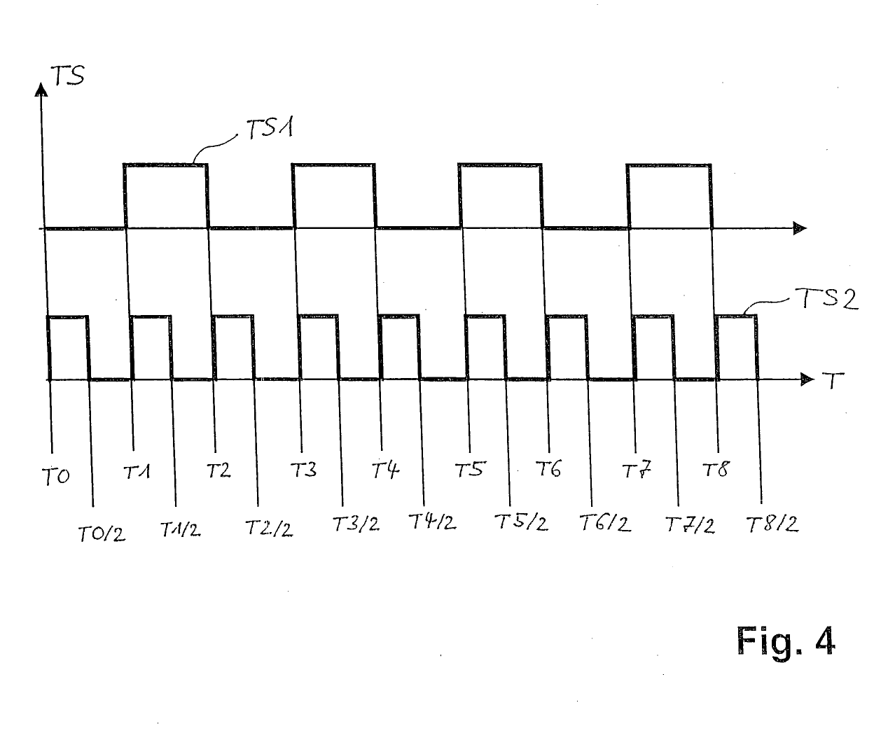

FIG. 4 illustrates the full cycle by TS 1, and the half cycle is illustrated by TS 2. In safety mode SM the operands are conveyed to the two execution units in a redundant manner in each full cycle TS 1, where they are processed at the same full cycle, in particular. In a fully synchronous processing of the operands the results are then able to be compared directly; otherwise a synchronization must take place, for the result comparison at the latest. In performance mode PM, the second operating mode, the feed unit operates at a half cycle, so that, for instance, the first operand(s) is/are supplied to one execution unit at T1, and the next operand(s) is/are supplied to the other execution unit at T1/2, so that the first and next operands are processed in the execution units in a full cycle-cycle. For example, in performance mode PM, the individual execution units, i.e., especially operand registers 8 and 9, operate at a faster clock cycle than the execution units, in particular at twice the speed. Decoder 303 for acting upon second switching means 304, which applies the corresponding control signals to the execution units, also operates on the basis of this faster cycle, in particular at twice the speed.

The principle of the present invention may be used for execution units having at least two operand inputs as shown in FIGS. 1, 2 and 3, i.e., for execution units which process or require a plurality of operands, but also for execution units which have only one operand input as shown in FIG. 5.

FIG. 5 essentially shows the same elements already described in connection with FIG. 3, with the exception that execution units 500 and 501 have only one operand input. Accordingly, only one operand register 8 is provided and correspondingly, buffer registers 110 and 210. The same applies to the associated elements with regard to error detection code ECC, elements 110A, 210A with corresponding comparators 15C and 25C. First switching means 508 and 510 correspond to switching means 308 and 310 in FIG. 3, and first switching means 509 and 511 correspond to switching means 309 and 311. Here, too, the ECC elements are optional. The first switching means may once again be separate or included in the corresponding register. Here the operands are supplied sequentially, and in performance mode PM—the second operating mode—they are alternately supplied to the execution units at a half cycle. In safety mode SM the operands are supplied to the execution units using the full cycle, so that the same operand will be supplied in each case and processed in the execution units in a redundant manner. Within the framework of this functionality, control circuit 57 corresponds to control circuit 37 of FIG. 3, with the exception that it relates to the one-operand principle. In the same manner, control unit 502 corresponds to control unit 302 from FIG. 3, once again relating to the one-operand principle and the adaptations associated therewith.

The results and/or states in safety mode SM are compared to each other at the output (optionally also ECC, only if the error-detection code unit is to be tested as well), as described in connection with FIG. 3. Error-detection code ECC is formed from this result preferably only after the result has been compared, thereby ensuring that the codings were formed from a correct result. In performance mode PM the results of the execution units are transmitted to the bus sequentially, in the sequence in which the operands were supplied to the execution units. The continuity of the concept may be optimized in that all illustrated ECC codings are formed and checked and transmitted to the bus as well, various stages of this continuity or safety relevance being possible.

All mentioned exemplary embodiments are essentially comparable according to the principle of the present invention and are thus able to be combined and joined as desired. Additional specific embodiments within the framework of the principles of the present invention are possible, so that these specific embodiments should not be considered restrictive in this regard. This also means that the statements made in connection with the individual exemplary embodiment are also applicable to and valid for the other specific embodiments within the principle of the present invention.

1-24. (canceled)

25. A method for processing operands in a processing unit having at least two execution units, comprising:
operating the executing units at a predefinable clock cycle;
triggering the execution units by control signals for a processing of the operands;
switching between a first operating mode and a second operating mode;
in the first operating mode, supplying the execution units with the same operands; and
in the second operating mode, supplying the execution units with different operands,
wherein:
the execution units are triggered by the same control signals for the processing of the operands in the first operating mode, and
the execution units are controlled by different control signals for the processing of the operands in the second operating mode.

26. The method as recited in claim 25, further comprising:
supplying the operands to the execution units as a function of the clock cycle for operand processing of the execution units in the form of a full cycle; and
in the second operating mode, supplying the operands at a second clock cycle for the processing of the operands, the second cycle being faster than the full cycle, one of the execution units thereby receiving operands after a time offset passes from a time at which another of the execution units receives operands in a same clock cycle.

27. The method as recited in claim 26, wherein in the first operating mode the operands are supplied at the clock cycle of the execution units, as full cycle.

28. The method as recited in claim 26, wherein, compared to the full cycle, the faster second clock cycle is designed as half cycle and is twice as fast and the time offset is equal to half of the full cycle.

29. The method as recited in claim 25, wherein the execution units process the operands in synchrony in the first operating mode and the second operating mode.

30. The method as recited in claim 25, further comprising:
processing the operands in synchrony in the first operating mode; and
processing the operands in asynchrony in the second operating mode.

31. The method as recited in claim 25, further comprising:
comparing one of the operands and data derived from the operands for agreement; and
detecting an error in case of a deviation.

32. The method as recited in claim 25, further comprising:
comparing one of states and results produced in the processing of the operands for agreement; and
detecting an error in a deviation, the comparison being implementable as a function of the individual operating mode.

33. The method as recited in claim 32, further comprising:
releasing the one of the states and the results by a release signal as a function of the operating mode and the comparison.

34. The method as recited in claim 32, further comprising:
releasing the one of the states and results by a release signal one of simultaneously and successively as a function of the operating mode.

35. A device for operand processing in a processing unit having at least two execution units, comprising:
an arrangement for operating the execution units at a predefinable clock cycle; and
a control unit for triggering the execution units by control signals for a processing of the operands and for switching between a first operating mode and a second operating mode,
wherein:
the control unit is connected to the execution units and additional feed units,
the control unit cooperates with the feed units in such a way that both execution units are supplied with the same operands in the first operating mode and both execution units are supplied with different operands in the second operating mode, and
the control unit being designed such that both execution units are triggered by identical control signals for the processing of the operands in the first operating mode and both execution units are triggered by different control signals for the processing of the operands in the second operating mode.

36. The device as recited in claim 35, wherein the control unit and the feed units are designed such that in the first operating mode the operands are supplied to the execution units as a function of the clock cycle of the execution units, as full cycle, and in the second operating mode the operands are supplied for processing at a second clock cycle, which is faster than the full cycle, one of the execution units thereby receiving operands after a time offset passes from a time at which another of the execution units receives operands in a same clock cycle.

37. The device as recited in claim 35, wherein the execution units are embodied as at least one of arithmetic logic units, floating point units, processors, and a coprocessor.

38. The device as recited in claim 35, wherein the feed units and the execution units are designed such that in the first operating mode they operate in synchrony using an identical clock cycle.

39. The device as recited in claim 35, wherein the feed units as register system are designed such that at least one operand register is provided and at least one buffer register is provided between operand register and each execution unit.

40. The device as recited in claim 35, wherein the feed units and the execution units are designed such that they operate at different clock cycles in the second operating mode.

41. The device as recited in claim 35, wherein the feed units are designed such that in the second operating mode they operate at a clock cycle that is twice as fast as that of the execution units.

42. The device as recited in claim 35, further comprising:
a decoder by which a switchover condition is detectable, wherein the decoder operates at the same clock cycle as the feed units.

43. The device as recited in claim 35, further comprising:
a comparison arrangement designed such that one of the operands and data derived from the operands are compared for agreement, wherein an error is detected in case of a deviation.

44. The device as recited in claim 35, further comprising:
a comparison arrangement designed such that states produced in the processing of the operands are compared for agreement, wherein an error is detected in case of a deviation.

45. The device as recited in claim 35, further comprising:
a first switching arrangement for switching the operands from the feed units as a function of one of the first operating mode and the second operating mode.

46. The device as recited in claim 45, further comprising:
a second switching arrangement for activating the execution units as a function of one of the first operating mode and the second operating mode.

47. A processing unit, comprising:
a device for operand processing having at least two execution units that are able to be operated at a predefinable clock cycle; and
a control unit for triggers the execution units by control signals for the processing of the operands and for switching between a first operating mode and a second operating mode,
wherein:
the control unit is connected to the execution units and additional feed units,
the control unit cooperates with the feed units in such a way that both execution units are supplied with the same operands in the first operating mode and both execution units are supplied with different operands in the second operating mode, and
the control unit being designed such that in the first operating mode both execution units are triggered by the same control signals for the processing of the operands and in the second operating mode both execution units are triggered by different control signals for the processing of the operands.
